(19) United States
(12) Patent Application Publication
(10) Pub. No.: US 2009/0125762 A1
(43) Pub. Date: May 14, 2009

(54) APPARATUS FOR REPAIRING AND/OR TESTING A MEMORY DEVICE

(76) Inventor: Feng Wang, Xi'an (CN)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 12/266,215

(22) Filed: Nov. 6, 2008

(30) Foreign Application Priority Data
Nov. 9, 2007 (DE) DE 102007053464.9

(51) Int. Cl. G06F 11/26

(52) U.S. Cl. 714/718; 714/E11.159

(57) ABSTRACT

Embodiments of the invention relate to an apparatus for repairing and/or testing at least one memory device having a plurality of memory cells, the apparatus comprising an interface which is adapted to accommodate a memory device; means for determining the type of memory device; a selection memory for storing at least one repair and/or test program; and selection means for selecting a repair and/or test program from the selection memory. Another embodiment of the invention relates to a method for repairing and/or testing at least one memory device having a plurality of memory cells, the method comprising: connecting a memory device to an apparatus for repairing and/or testing a memory device; determining the type of memory device by means of said apparatus; selecting at least one repair and/or test program from a selection memory being part of the apparatus for repairing and/or testing a memory device; executing the selected program, and thereby deactivating addresses of defective memory cells of the memory device and/or reallocating addresses of functional memory cells to addresses of defective memory cells.

### CROSS-REFERENCE TO RELATED APPLICATIONS

This application claims foreign priority benefits under 35 U.S.C. § 119 to co-pending German patent application number DE 10 2007 053 464.9, filed 9 Nov. 2007. This related patent application is herein incorporated by reference in its entirety.

### BACKGROUND OF THE INVENTION

The present invention relates to an apparatus for repairing and/or testing microelectronic devices, in particular memory devices. In particular, the invention relates to an apparatus for repairing and/or testing memory devices having one or more memory cells. In this case, the memory device may comprise, for example, DRAM, SRAM, CBRAM or flash EEPROM memory cells.

### SUMMARY OF THE INVENTION

In one embodiment, the invention relates to an apparatus for repairing and/or testing at least one memory device having a plurality of memory cells, comprising an interface which is adapted to accommodate a memory device; means for determining the type of memory device; a selection memory for storing at least one repair and/or test program; and selection means for selecting a repair and/or test program from the selection memory.

In another embodiment, the invention relates to a an apparatus for repairing and/or testing at least one memory device having a plurality of memory cells, comprising an interface which is adapted to accommodate a memory device; means for determining the type of memory device; a selection memory for storing at least one repair and/or test program; selection means for selecting a repair and/or test program from the selection memory; and a device adapted to deactivate addresses of defective memory cells of the memory device and/or to reallocate addresses of functional memory cells to addresses of defective memory cells.

In still another embodiment of the invention, the invention relates to a method for repairing and/or testing at least one memory device having a plurality of memory cells, the method comprising the following steps: connecting a memory device to an apparatus for repairing and/or testing a memory device; determining the type of memory device by means of said apparatus; selecting at least one repair and/or test program from a selection memory being part of the apparatus for repairing and/or testing a memory device; executing the selected program, and thereby deactivating addresses of defective memory cells of the memory device and/or reallocating addresses of functional memory cells to addresses of defective memory cells.

### BRIEF DESCRIPTION OF THE DRAWINGS

In order to provide a more detailed understanding of the above-described features of the present invention, a more detailed description of the invention, which was summarized briefly above, is specified below with reference to embodiments, some of which are illustrated in the accompanying drawings. However, it is pointed out that the drawings only show typical embodiments of the invention and therefore do not restrict the scope of the latter. The invention may allow further embodiments which are equally effective.

FIG. 1 illustrates, in the form of a block diagram, the structure of an apparatus according to the invention.

FIG. 2 illustrates a flowchart of a method for repairing and/or testing a memory device according to the present invention.

### DETAILED DESCRIPTION OF THE PREFERRED EMBODIMENTS

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The present invention is described below with regard to different functional components. It is pointed out that such functional components may be implemented using hardware and/or software. The invention may use, for example, different integrated components whose method of operation is suitable for the intended purpose. A plurality of such components may be coupled to one another, such a coupling being implemented directly or using other components which are fitted in between.

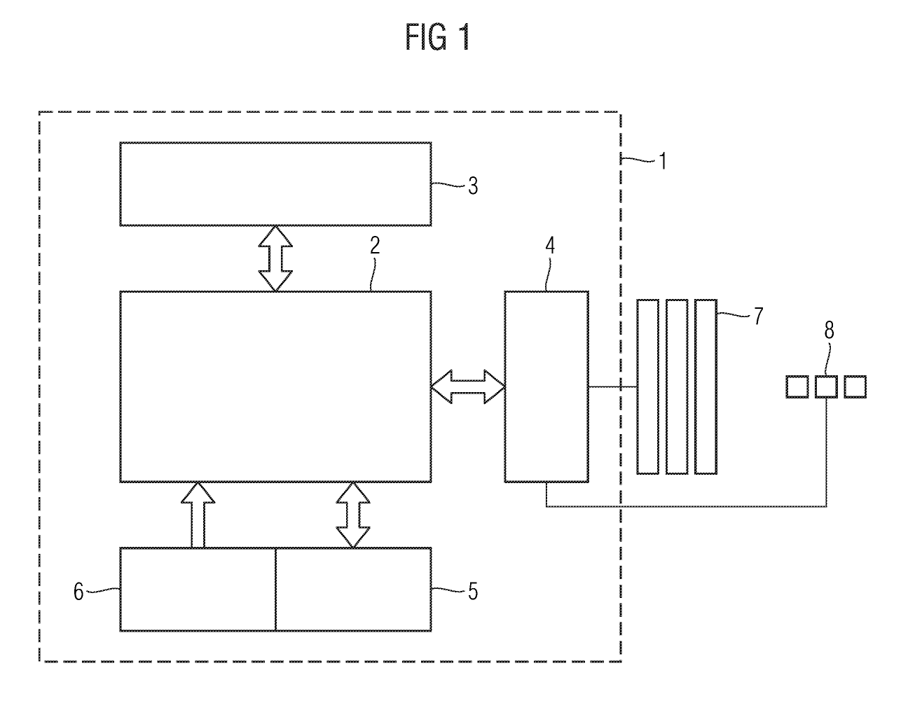

FIG. 1 illustrates the diagrammatic structure of an apparatus for repairing and/or testing at least one memory device according to the present invention. Embodiments of the invention may generally be used with any type of memory. In one embodiment, the memory may be a circuit included on a device with other types of circuits. For example, the memory may be integrated into a processor device, memory controller device, or other type of integrated circuit device. Devices into which the memory is integrated may include system-on-a-chip (SOC) devices. In another embodiment, the memory may be provided as a memory device which is used with a separate memory controller device or processor device.

In some cases, a device including the memory may be packaged together with other devices. Such packages may include any other types of devices, including other devices with the same type of memory, other devices with different types of memory, and/or other devices including processors and/or memory controllers. Also, in some cases, the memory may be included in a device mounted on a memory module. The memory module may include other devices including memories, a buffer chip device, and/or a controller chip device.

In some cases, embodiments of the invention may be used with multiple types of memory or with a memory which is included on a device with multiple other types of memory. The memory types may include volatile memory and non-volatile memory. Volatile memories may include static random access memory (SRAM), pseudo-static random access memory (PSRAM), and dynamic random access memory (DRAM). DRAM types may include single data rate (SDR) DRAM, double data rate (DDR) DRAM, low power (LP) DDR DRAM, and any other types of DRAM. Nonvolatile memory types may include magnetic RAM (MRAM), flash memory, resistive RAM (RRAM), ferroelectric RAM (FeRAM), phase-change RAM (PRAM), electrically erasable programmable read-only memory (EEPROM), laser programmable fuses, electrically programmable fuses (e-fuses), and any other types of nonvolatile memory.

The apparatus 1 for repairing and/or testing at least one memory device comprises at least one central processing unit 2, at least one user interface 3 for interacting with a user, at least one selection memory 6, a main memory 5 and an I/O interface 4.

The central processing unit 2 comprises, for example, a microprocessor or a microcontroller. In further embodiments of the invention, the apparatus 1 for repairing and/or testing at least one memory device may comprise further components which provide, for example, a graphical user interface, an alarm or warning signal apparatus or test routines for the test device 1 itself.

When operating the apparatus described, the central processing unit 2 receives commands from the user interface 3. As an example, a user may be informed by means of the user interface 3 to receive information relating to a memory device to be tested, such as the manufacturer, the type, technical data relating to the performance, or errors which have been determined. Furthermore, the central processing unit 2 may also receive commands from the user via the user interface 3. For example, the user can in this case start a test or a repair routine, can select one of a plurality of possible test or repair routines or can set the type of memory device used. For this purpose, the user interface 3 may be provided with an LED, LCD or CRT display apparatus. Switches, keys or touch screens may be available, for example, for the purpose of input. User interaction by means of voice control and/or voice output is also possible.

Test and/or repair routines which are intended to be used for the memory device are stored in a selection memory 6. This memory is, for example, a ROM memory. The latter may be in the form of a semiconductor memory, for example a PROM, an EPROM or an EEPROM. In another embodiment, the selection memory may comprise an optical storage medium, for example a CD or a DVD or a magnetic storage means such as a hard disk.

In one embodiment of the invention, the central processing unit 2, the user interface 3 and the test and/or repair routines stored inside the selection memory 6 may co-operate as such that an inexperienced user, such as an end user or a shop assistant in a store selling the memory devices to be tested, may be able to carry out the test and/or repair function of the apparatus described. This may be achieved by means of an automatic detection of the type of memory device, the type of errors and the method for repairing these errors after coupling a memory device with the apparatus and starting the test and/or repair function.

The data involved during operation of the repair and/or test apparatus are loaded into the main memory 5. The latter is preferably a RAM memory, for example a DRAM memory. The main memory 5 may also receive the program parts required for execution from the selection memory 6. However, it is also contemplated that the central processing unit 2 may directly load the unalterable program parts from the selection memory 6 and that only the alterable data be stored in the main memory 5.

An I/O interface is provided in order to make the data to be tested available, from a memory device, to the apparatus 1 and to the central processing unit 2. Said interface is connected to at least one mounting device for accommodating a memory device to be tested. The mounting devices 7 and 8 constitute a mechanical holder for the memory device to be repaired or checked. The mounting devices 7 and 8 may also establish the electrical connection between the memory device to be tested and the I/O interface. The mounting devices 7, 8 may also be of multipart design in order to achieve this functionality. Different mounting devices which are adapted to respectively different memory devices may be provided. By way of example, a receptacle 7 for elongated memory modules is illustrated, which can accommodate, for example, SDRAM or DDR memory modules. In addition, provision may also be made of, for example, smaller sockets 8 which accommodate individual memory chips in packages, for example a memory chip in a SMD package. These examples of a mounting device are merely illustrative and do not restrict the present invention in any way. Further mounting devices may be provided, for example needle plates for contact-connecting unhoused components or readers for memory cards, for example CF, SD, MMC or xD cards. A person skilled in the art will respectively adapt the type and number of mounting devices used to the memory devices to be tested.

The apparatus according to the invention also has means for determining the type of memory devices accommodated in a mounting device 7 or 8. These means for determining the type of memory device may be arranged either in the I/O interface 4 or in the central processing unit 2 or may be in the form of a separate functional unit of the apparatus 1.

In one embodiment, the selection means may comprise a device for reading an SPD (Serial Presence Detect) memory. The typical data of a memory device may be written to such an SPD memory when producing the memory device. These data may be made available to the apparatus 1 by reading this memory.

In another embodiment, the means for determining the type of memory device may carry out at least one test on the memory device. Conclusions as to the memory device inserted into a mounting device 7 or 8 can be drawn from one or more tests on the memory device. The tests to be carried out in order to identify the memory device may include, for example, an access time, a data rate for read transmission, a data rate for write transmission, the number of electrical contacts or the storage capacity of the memory device. Without restricting the general concept of the invention, a person skilled in the art having the benefit of the present disclosure may recognize a multiplicity of other tests which allow conclusions to be drawn as to the memory device in a mounting device 7 or 8. The operation of carrying out a test on the memory device may involve writing and/or reading special test data. In addition to determining the type of memory device, the result of such a test can also be used to detect an error in the memory device.

In a further embodiment of the disclosed apparatus, the means for determining the type of memory device may have a selection device which can be operated by the user. This selection device may be integrated in the user interface 3. For example, it is possible for the user to use the user interface 3 to directly transmit the type of memory device to be tested and/or repaired to the central processing unit 2. In another embodiment, an automated selection apparatus may also be used to make a preselection, this preselection being displayed for the user using the user interface 3 and the user making a definitive selection.

On the basis of the determined or selected type of memory device, the central processing unit 2 may use the I/O interface 4 to apply a test program and/or a repair program selected from the selection memory 6 to the memory devices in the mounting device 7 and/or 8. In this case, the test and/or repair program can be preselected using the determined type of memory device. The selected programs can then be either directly applied to the memory device or the user may make a selection from the programs offered.

If a test program which is applied to the memory device detects an error in the memory device, a repair program can be started immediately if it is an error which can be repaired. In the case of an irreparable error, this may be signaled to the user using the user interface 3. Furthermore, a repairable error may be reported to the user using the user interface 3, a repair operation being carried out after the user has given a corresponding repair command using the user interface 3.

The operation of repairing an error may involve, for example, masking a defective memory cell, with the result that data cannot be lost by virtue of being written to a defective memory cell. If the memory device supports this function, the addresses of defective memory cells may also be reallocated to spare memory cells in the memory device. In this case, the storage capacity of the memory device remains unaltered. On account of the fact that the memory device has been identified, it is possible to prevent a repair program which is not suitable for the memory device from running. Repair attempts which are, in principle, not available in the memory device used or could damage the latter are therefore not carried out either.

Furthermore, different repair programs may be available for different possible errors in a memory device. These programs may then be applied not only on the basis of the memory device but also on the basis of the error detected by a test program.

In another embodiment of the invention, the proposed apparatus for repairing and/or testing a memory device may also be integrated in a further device. This device may be, for example, a personal computer, a server, a network switch or a consumer product such as a digital video camera or a music player. The apparatus according to the invention can be integrated in all electronic devices which comprise a memory device. It is thus possible for the device to test its own memory device as part of its self-diagnosis and to repair it if necessary.

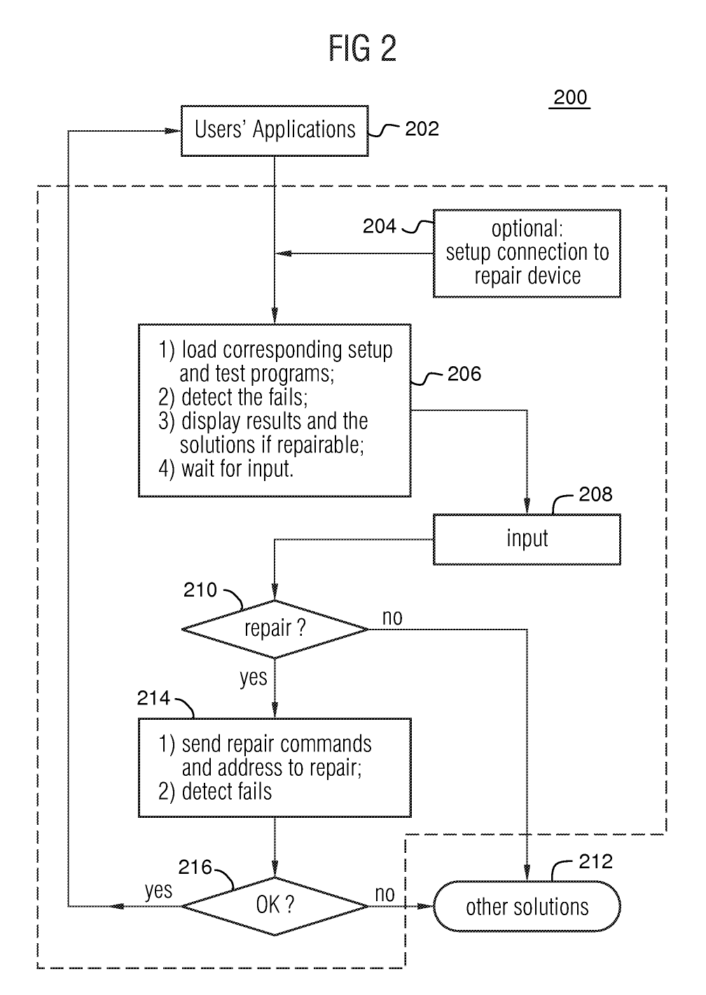

FIG. 2 shows a flowchart illustrating a sequence 200 of the repair and/or test method according to one embodiment of the invention. In the first method step 202, the memory device is used by a user in a device. The corresponding use may include use in a computer, a video camera, a server, a network switch or a programmable controller. It goes without saying that the use of the memory device is not restricted to these examples. If the device comprising the memory apparatus has integrated an apparatus 1 according to the invention for repairing and/or testing a memory device, testing of the memory device can be started directly from the user's application. In an alternative embodiment, the user's device does not have an apparatus 1 according to the invention. The memory device must then be removed from the user's device and inserted into an apparatus 1 according to the invention, as shown by step 204. The apparatus according to the invention for repairing and/or testing a memory device then determines the type of memory device. An SPD memory, for example, may be read for this purpose. Alternatively, tests which allow conclusions to be drawn as to the memory device used may be carried out. For example, for an access time of 8 ms and a storage capacity of 80 GB, the apparatus according to the invention may conclude that the memory device is a magnetic hard disk. A memory device having a storage capacity of 1024 MB and an access time of 5 ns may be a DRAM. After step 202 has been concluded, either the type of memory device is determined in a fully automated manner or else possible types are selected and are displayed to the user using the user interface 3. After one of the displayed types has been selected by the user, the identification of the memory device is also fully concluded in this case.

At step 206, a test program which is suitable for the respective memory device is selected and loaded from the selection memory 6. This test program is used to detect errors in the memory device in question. The errors may include, for example, one or more defective memory cells, insufficient storage durations, long access times or the like. In the case of very extensive test programs, provision may be made for the user to select the parameters to be tested using the user interface 3. The result of the test or tests carried out is indicated to the user using the user interface 3. If the errors indicated can be repaired, this fact is also indicated to the user. The user can now decide whether to carry out a repair operation. During this time, processing of the corresponding repair and test routines is suspended. The user inputs the desired selection to the user interface 3 at step 208. If the user decides against a repair operation or there are only irreparable errors (as determined at step 210), the program ends the rest of the operation of repairing the memory device (step 212). The user must then search for other solutions, for example replacement of the memory device.

If the user input indicates that the user would like to carry out the repair operation (as determined at step 210), processing proceeds to step 214 where the repair program suited to the associated memory device and the associated error is loaded from the selection memory 6. The central processing unit 2 then uses the I/O interface 4 to send repair commands to the memory device in the mounting device 7 or 8. These repair commands may comprise details of the type of repair operation to be carried out and the addresses to be repaired. In one embodiment, the apparatus is adapted to deactivate addresses of defective memory cells of the memory device and/or to reallocate addresses of functional memory cells to addresses of defective memory cells.

After the repair operation has been carried out, a corresponding test program is again loaded from the selection memory 6. Following this, test commands are again sent to the memory device using the I/O interface 4. At step 216 the sequence determines whether any further errors are detected. If the repair operation was successful, no further error is determined. The user is informed of this state via the user interface 3. The user can then use the memory device again. If errors are still determined (at step 216) after the repair attempt, the repair operation has failed. This state is also output to the user. The user must now try to find another solution, for example the replacement of the memory device in question.

It goes without saying that it is not necessary to carry out all of the method steps stated here in the exact order. Rather, a person skilled in the art is at liberty to rearrange individual method steps or to omit them completely. For example, in one embodiment, it is not necessary to wait for a user input before a repair operation. Rather, the apparatus according to the invention can immediately repair all errors which have been detected. Nor is it necessary, following the repair operation, to check the success of the latter by calling a test routine again. Furthermore, a user may directly input the error to the apparatus 1 and/or the repair routine to be used using the user interface 3 if he is already aware of the type of error. In the same manner, it is possible to omit further method steps or to add further method steps without changing the subject matter of the invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus for repairing and/or testing a memory device having a plurality of memory cells, the apparatus comprising:
an interface adapted to accommodate the memory device;
means for determining the type of the memory device;
a selection memory for storing at least one repair and/or test program;
selection means for selecting a repair and/or test program from the selection memory; and
a device adapted to deactivate addresses of defective memory cells of the memory device and/or to reallocate addresses of functional memory cells to addresses of defective memory cells.

2. The apparatus according to claim 1, wherein the selection memory contains a plurality of repair and/or test programs which can be selected on the basis of the type of memory device.

3. The apparatus according to claim 1, wherein the means for determining the type of memory device comprise a device for reading an SPD memory.

4. The apparatus according to claim 1, wherein the means for determining the type of memory device are adapted to carry out at least one test on the memory device.

5. The apparatus according to claim 1, wherein the means for determining the type of memory device have a selection device which can be operated by the user.

6. The apparatus according to claim 1, wherein the selection memory comprises at least one test program which is usable to determine at least one error in the memory device.

7. The apparatus according to claim 1, wherein the selection memory comprises a multiplicity of repair programs which are respectively usable to correct different errors in the memory device.

8. The apparatus according to claim 7, wherein a repair program is selectable from the selection memory by means of a user input.

9. An apparatus for repairing and/or testing a memory device having a plurality of memory cells, comprising:
an interface which is adapted to accommodate the memory device;
means for determining the type of the memory device;
a selection memory for storing at least one repair and/or test program; and
selection means for selecting a repair and/or test program from the selection memory.

10. The apparatus according to claim 9, said apparatus being intended to be operated by an inexperienced user.

11. The apparatus according to claim 9, wherein the selection memory contains a plurality of repair and/or test programs which can be selected on the basis of the type of memory device.

12. The apparatus according to claim 9, wherein the means for determining the type of memory device comprise a device for reading an SPD memory.

13. The apparatus according to claim 9, wherein the means for determining the type of memory device are adapted to carry out at least one test on the memory device.

14. The apparatus according to claim 9, wherein the selection memory comprises a plurality of repair programs which are respectively usable to correct different errors in the memory device.

15. The apparatus according to claim 9, comprising further a device adapted to deactivate addresses of defective memory cells of the memory device and/or to reallocate addresses of functional memory cells to addresses of defective memory cells.

16. A method for repairing and/or testing a memory device having a plurality of memory cells, the method comprising:
connecting the memory device to an apparatus for repairing and/or testing the memory device;
determining the type of the memory device by means of said apparatus;
selecting at least one repair and/or test program from a selection memory being part of the apparatus for repairing and/or testing the memory device;
executing the selected program, and thereby
deactivating addresses of defective memory cells of the memory device and/or reallocating addresses of functional memory cells to addresses of defective memory cells.

17. The method according to claim 16, wherein at least one program is selected from a plurality of repair and/or test programs in a selection memory on the basis of the type of memory device.

18. The method according to claim 16, wherein at least one SPD memory is read in order to determine the type of memory device.

19. The method according to claim 16, wherein at least one test is carried out on the memory device, which test allows conclusions to be drawn as to the type of memory device and/or determines errors in the memory device.

20. The method according to claim 16, wherein at least one program is selected from a plurality of repair programs in the selection memory on the basis of the error determined in the memory device.

21. The method according to claim 16, wherein a repair program is selected from the selection memory by means of a user input.

22. The method according to claim 16, wherein a memory device which comprises DRAM memories and/or EEPROM memories and/or SRAM memories is repaired and/or tested.
